(19) United States
(12) Patent Application Publication
(10) Pub. No.: US 2013/0013447 A1
(43) Pub. Date: Jan. 10, 2013

(54) SYSTEM AND METHOD FOR DETERMINING THE BEST SIZE OF PRODUCTS FOR ONLINE AND OFFLINE PURCHASE

(76) Inventors: Ravishankar Chityala, Minneapolis, MN (US); Nicholas Labello, Oak Park, IL (US)

(21) Appl. No.: 13/541,934

(22) Filed: Jul. 5, 2012

Related U.S. Application Data
(60) Provisional application No. 61/505,276, filed on Jul. 7, 2011.

(51) Int. Cl. G06Q 30/00

(52) U.S. Cl. 705/26.7

(57) ABSTRACT

An apparel item sizing process for ascertaining best fitting apparel items from a plurality of product offerings, the process includes collecting apparel item details by inputting into an electronic database apparel item details for a plurality of brand manufacturers or retailer. The process further includes the apparel item details of at least one item type, brand name, brand line, pricing, dimensions, color, potential popularity based on reviews, location, and ratings. The process utilizes an computational analysis system to determine a closeness of fit score of one or more apparel items of interest to a reference apparel item utilizing the collected apparel item details. The reference apparel item is an item known to fit a customer based upon prior experience and the closeness of fit score is derived from a formula utilizing at least one critical dimension that is key to the satisfaction of the customer.

CROSS-REFERENCE TO RELATED APPLICATION(S)

The present application claims priority to U.S. Provisional Application No. 61/505,276, filed on Jul. 7, 2011 and entitled “METHOD FOR DETERMINING THE BEST SIZE OF PRODUCTS FOR ONLINE AND OFFLINE PURCHASE” products, the disclosure of which is incorporated by reference in its entirety.

### BACKGROUND

The success of the internet has influenced significantly the development and progress of e-commerce. The internet allows purchasers to access products at bargain prices. Retailers and vendors can also acquire a better understanding of the markets by analyzing pricing schemes of competitors, and purchasing habits of consumers.

Purchasers can buy a wide variety of products online, but the purchase of such products is usually limited to products where dimensions or size are not critical to customer satisfaction. Therefore, purchase of items where a good fit is critical is frequently not made on the internet, but instead in brick and mortar stores where the item can be visually or otherwise directly inspected to ensure a good fit. When such purchases are made on the internet, and the product does not fit the customer, it is often returned at a cost to the vendor, resulting in reduced revenue, and sometimes, in price increases to the consumer. Therefore, there remains a need for a system which can accurately recommend the size of a product to be purchased on the internet based on information that the purchaser can readily provide. This system could also be used when purchasing at a brick-and-mortar store (a.k.a) offline purchase.

### SUMMARY

An apparel item sizing process for ascertaining best fitting apparel items for a particular apparel item type from a plurality of product offerings, the process includes collecting apparel item details for future analysis and dissemination by inputting into an electronic database apparel item details for a plurality of brand manufacturers or retailer. The process further includes the apparel item details of at least one categorical apparel item type, brand name, brand line, pricing, apparel item dimensions, apparel item color, potential apparel item popularity based on reviews, location of the apparel item, and apparel item ratings. The process utilizes an electronically implemented computational analysis system to determine a closeness of fit score of one or more apparel items of interest to a reference apparel item utilizing the collected apparel item details. The reference apparel item is an item known to fit a customer based upon prior experience and the closeness of fit score is derived from a formula utilizing at least one critical dimension that is key to the satisfaction of the customer.

An apparel item sizing system for ascertaining best fitting apparel items for a particular apparel item type from a plurality of product offerings, the system includes at least one server for hosting a website, the website including an input form for inputting details of a reference apparel item including at least one of the brand, type or size of the reference apparel item. The system further includes at least one electronic database that stores apparel item details and customer details and the apparel item details include at least one of categorical apparel item type, brand name, brand line, pricing, apparel item dimensions, apparel item color, potential apparel item popularity based on reviews, location of the apparel item, and apparel item ratings. The system includes apparel item sizing software that is adapted to determine a closeness of fit score of one or more apparel items of interest to the reference apparel item utilizing the stored apparel item details, wherein the reference apparel item is an item known to fit a customer based upon prior experience, and wherein the closeness of fit score is derived from a formula utilizing at least one critical dimension that is key to the satisfaction of the customer.

A computer program stored on computer readable medium to implement a method for ascertaining best fitting apparel items for a customer from a plurality of product offerings, the method includes inputting onto a electronic database apparel item details for a plurality of brand manufacturers or retailer, the apparel item details comprising at least one of categorical apparel item type, brand name, brand line, pricing, apparel item dimensions, apparel item color, potential apparel item popularity based on reviews, location of the apparel item, and apparel item ratings. The method inputs via a form certain details of the reference apparel item including at least one of the brand, type or size of the reference apparel item, and wherein the customer is prompted to choose from pre-determined apparel choices or has the option to enter a search term to better select the one or more apparel items of interest. The method utilizes an electronically implemented computational analysis system to determine a closeness of fit score of one or more apparel items of interest to a reference apparel item utilizing the collected apparel item details, wherein the reference apparel item is an item known to fit a customer based upon prior experience, and wherein the closeness of fit score is derived from a formula utilizing at least one critical dimension that is key to the satisfaction of the customer.

### BRIEF DESCRIPTION OF THE DRAWINGS

FIG. 1 is a flow diagram illustrating various phases of the invention.

FIG. 2A is a screen print of one embodiment of a user interface and input screen.

FIG. 2B is a screen print of a second embodiment of a user interface and input screen.

FIG. 3 is a screen print of one embodiment of a user interface and output search results screen.

FIG. 4 is a screen print of one embodiment of a user interface that allows a customer to modify search results.

FIG. 5 is a simplified diagram illustrating interactions of various parts of one embodiment of the invention.

FIG. 6 is a flow diagram illustrating various sub-processes executed by the various parts of FIG. 1.

FIG. 7 is a flow diagram illustrating various sub-processes executed by the system including sub-processes potentially executed with an offline database version of the system and sub-processes executed with an online database version of the system.

### DETAILED DESCRIPTION

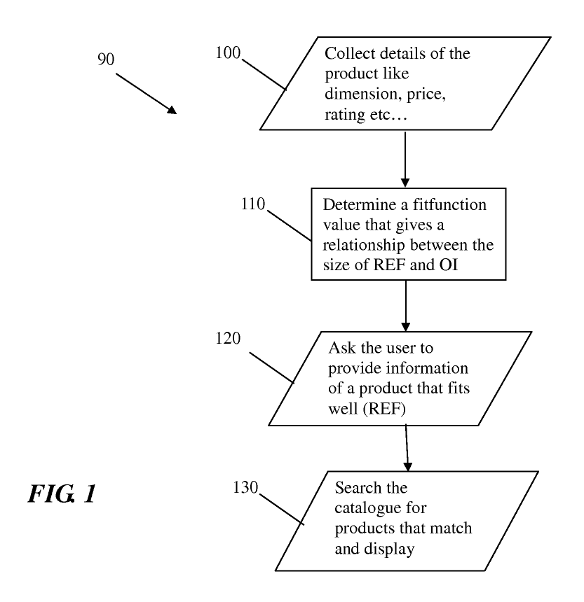

The invention involves three phases of a process 90, which are generally outlined by the flow diagram of FIG. 1. The first phase of the process 90 illustrated in FIG. 1 is “cataloging.” Cataloging is identified as step 100 in FIG. 1. In this phase, the dimensions of different products sold by a vendor/manufacturer are measured or obtained by another method, such as curating data provided by the manufacturer, and stored in a database or file for future analysis and dissemination.

In the second phase, “fitfunction determination”, identified as step 110 in FIG. 1, “closeness of fit” of the other item (herein after referred as I) relative to a reference item (herein after referred as REF) is determined for a given set of physical dimensions. In another embodiment, the fitfunction determination (closeness of fit) is carried out in real time, immediately following the input of information by the user about the REF item.

In the third phase, called the “purchase phase”, identified as step 120 in FIG. 1, the customer inputs a REF that fits them well. The database is searched for items that match the user's specifications, and additionally are of the same or similar dimension as the REF. In one embodiment, only the product that meets all dimensional requirements of the customer is displayed. In another embodiment, the results are arranged so that the products meeting most criterions are presented first and products that meet fewer criterions are presented later. The user is allowed to narrow their searches based on price, color, ratings etc.

The Cataloging Phase

Offline cataloging can be performed as part of the cataloging phase 100 discussed previously. During the cataloging phase 100, the details of products such as size in several dimensions, the image of the product, its price, its ratings etc. are collected. These data are stored in a database or file. The images of different products sold by a vendor or manufacturer are captured using standard image capturing devices or equipment. They can also be collected from the manufacturer database or catalogs or internet webpages or from third party database or using Application Programming Interface (API) provided by various companies. The dimensions of the products are determined and cataloged in a database for future reference.

Since the data about the products change continuously, cataloging 100 can be performed at run-time during the purchase phase 120. The methods for online cataloging are same as described above for offline cataloging.

The Fitfunction Determination Phase

In the process 90, step 110 is performed to determine OI products of a similar size to the REF products. The fitfunction of step 110 can be pre-computed or computed at real-time. Real-time refers to calculating the fitfunction following user input of a reference item. Pre-computing saves the calculation that needs to be performed while the user is waiting for a response. If the dimensions change continuously or if the weights need to be changed, pre-calculating will not be useful. In such cases, the fitfunction must be calculated at run-time.

In one exemplary embodiment, step 110 proceeds by obtaining the dimension of the REF and OI from the database or file or from other means. In a subprocess of step 110, a fitfunction score is established. The fitfunction score utilizes at least one critical dimension, which will be discussed in further detail subsequently. For the purposes of this disclosure, the term “critical dimension” generally refers to any dimension of a product that is critical to the satisfaction of the customer. In one non-limiting example of the purchase of trousers, the dimensions of the waist, hips and inseam measurements are the critical dimensions.

Thus, in one embodiment the fitfunction measures the difference of critical dimensions between REF and OI, and scores how well the critical dimensions of the two items match. If the items have multiple critical dimensions, the final fitfunction score could be measured as a combination of the difference in each dimension between two products. Some of these dimensions might affect the fit more so than others. Hence a weight or penalty is assigned to each of the differences. The dimensions will have different weights depending on their criticality. For example, in the purchase of a women's trouser, the critical dimensions are waist, hip and inseam. Although all the three dimensions are critical, larger waist or hip dimensions of the product can be compensated by wearing a belt, however an inseam that is too long may require expensive alterations. Hence the weights or penalty for larger inseam is higher than the weights for waist and hip. Similarly, smaller sizes are penalized with a very large weight, so that users can only buy clothing that is either similar to or bigger than the REF. For example, if trousers are too small, most people would find them much more uncomfortable and generally less satisfying than trousers that are large by the same amount.

Symbolically, the fitfunction score (Score) for an exemplary trouser can be represented using the following formula 200:

Score=weight_{waist} (waist_{ref}−waistₒᵢ)+weightₕᵢₚ(hip_{ref}−hipₒᵢ)+weightᵢₙₛₑₐₘ(inseam_{ref}−inseamₒᵢ)

In the above formula 200, waist_{ref} is the value of the waist measurement that the reference product is designed to best fit in, for example, inches, and waistₒᵢ is the same measurement, but for the item that is being compared to the REF. weight_{waist} is a unitless coefficient that ranks the importance of the waist measurement relative to the other measurements in the function, in this case, hip and inseam. The hip and inseam variables in the function work in the same manner as the waist variables, but with hip and inseam measurements, respectively.

In one example of an application of process 90, consider a REF item of trousers sold by Vendor-A which fits a user well. In this case, the only information about the size of the product the user has available is that it is marketed as “Large.” The user would enter the brand (Vendor-A) and size (“Large”) into the invention described in this document. The invention then searches its database for the quantitative values of the critical dimensions of the product. In this example the critical dimensions are waist, hip, and inseam, which could be 30, 32, and 30 inches, respectively. Next, the invention will calculate a fit score of applicable items available to the user for purchase. For example, consider that Vendor-B sells a model of trousers with waist, hip, and inseam measurements of 31, 32 and 30 inches, respectively. By taking the differences between the critical measurements of the product the Score is calculated. The Score can then be mapped to qualitative assessments of the user satisfaction with the fit of the OI item. The qualitative assessment (“closeness of fit”) is presented with items available for purchase.

It should be noted that similar formulas exist for other products like upper-wear (t-shirt, shirt, polo . . . ) where the critical dimensions are chest, neck etc., lower-wear like trousers, skirt, shorts etc. where the critical dimensions are waist, hip, inseam etc. and also for dresses where the critical dimensions are a combination of critical dimensions of lower and upper-wear like chest, waist, hip, neck, and inseam. Thus, various formulas can be derived for any product that needs proper fitting size. It should be noted that in cases where there is a range for the critical dimensions, the formula(s) can be altered suitably. In the above example, the score is evaluated as linear combination of the various measurements. In other embodiments, a more complex approach using non-linear combinations of measurements and specific weightings for each measurement can be utilized depending on the type of product being compared and sold.

As a third subprocess, the fitfunction derived is stored in a database or a file for subsequent use.

The Purchase Phase

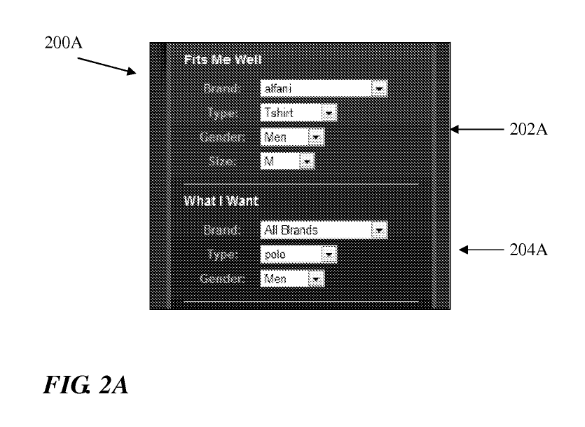

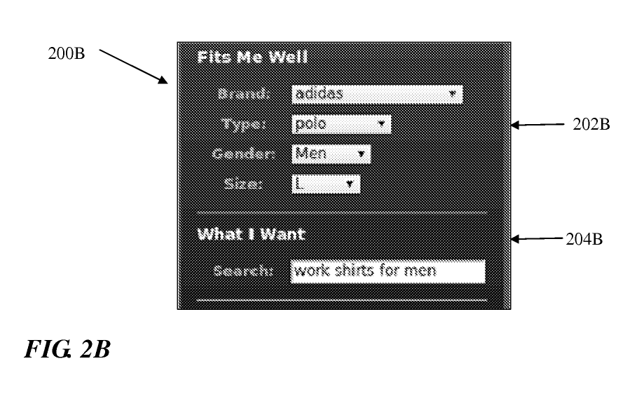

In the process 90 of determining OI products that matches the REF products in dimension, the following operation is performed during the purchase phase of step 120. A specific example of purchasing apparel is presented as follows and is illustrated in the screen prints of FIGS. 2A and 2B.

As shown in FIGS. 2A and 2B, input screens 200A and 200B prompt the user to input details of a product that fits them well. FIGS. 2A and 2B are two examples of the input screens 200A and 200B to obtain information about apparel that fits the user well. In both cases, the user is prompted to enter an item that fits them well using menu listed under category, “Fits Me Well” 202A and 202B. The difference between the two examples 200A and 200B lies in the category, “What I want” 204A and 204B. In input screen 200A of FIG. 2A, the user can choose from pre-determined choices in 204A. In contrast, in input screen 200B of FIG. 2B, the user enters a search term in 204B. In FIG. 2A, the user has specified in category 202A that an Alfani T-shirt of size medium for men fits him well, and that he is looking for a polo shirt for men of any brand in category 204A. In FIG. 2B, the user has indicated in category 202B that polo shirts of size “L” from the brand Adidas fit well, and that he is looking for men's work shirts in category 204B.

Based on the Score pre-calculated in the fitfunction, determine the OIs that most closely match the given REF item. If fitfunction is calculated at run-time, the process 90 follows the fitfunction determination phase 110 described previously.

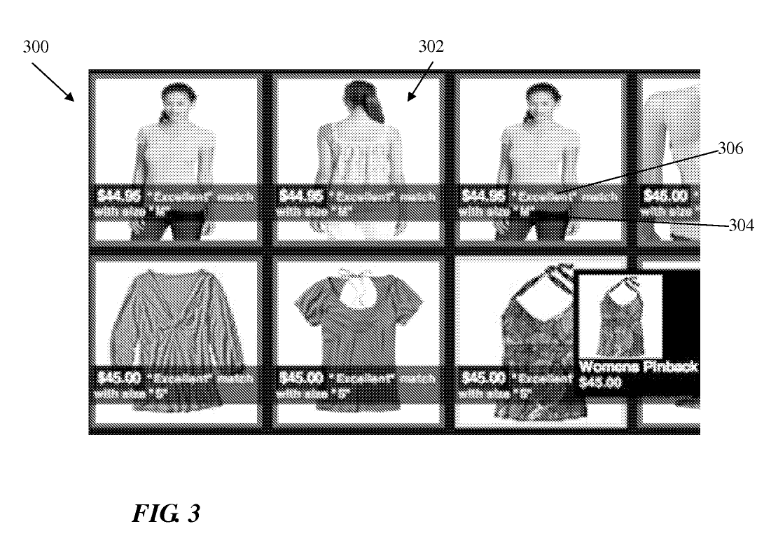

As shown in FIG. 3, search results 300 of apparel 302 are displayed to the user based on the fitfunction value, along with a recommendation 304 on the size of the item most likely to satisfy the user. In the search results 300 of FIG. 3, the user is presented apparels 302 that are an “Excellent match with size M” 306, indicating that if the user purchases a size M of the presented item the dimensions will align extremely well with those of the reference item, and thus be most likely to satisfy the user. Along with the image of the apparel 302, price, quality of match established using the fitfunction between REF and OI, size the user has to buy, ratings, name of the product, brand, details of the store where the product is available etc. are also presented.

The processes described, when applied to clothing in particular, allows a user of the invention to more confidently purchase apparel items on the internet because the invention identifies items most likely to fit well, reducing the need for inspecting the item in person (i.e., trying the item on).

In one embodiment of this invention, in addition to recommending clothing that fit them well from among a pool of ready to wear clothing, the details of item that fits our user well can be shared with a clothing designer, who could then design clothing based on the details from the item that fits the user.

In another embodiment, the invention can provide results for product available in a brick-and-mortar store through a website, application etc. The results among other things listed earlier will also include the location of the store, the location of product in the store, the quantity of product still available, the direction to the store, etc.

In another embodiment, the invention can provide results using a device like a computer, mobile phone, smart phone, tablet etc. located at the brick-and-mortar store. The results among other things listed earlier will also include the location of product in the store, the quantity of product still available, the direction to the product location, etc.

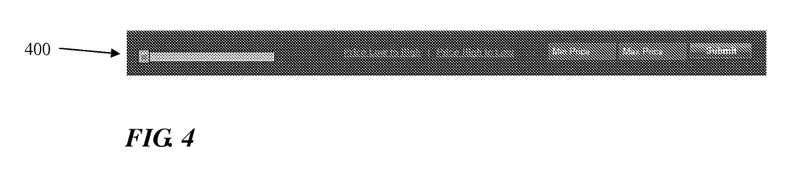

In a further embodiment shown in FIG. 4, the user is presented with a tool bar 400 that allows the user to further modify criteria such as price to narrow his or her decision. Other sorting methods includes (but not limited to) sorting by price, color, ratings, most reviewed, location of the product, etc.

Social Networking Applications

The user can be authenticated by the application. Once authenticated, the user will have a unique identifiable login name/number along with an associated password. When authenticated, any query made by the user can be stored in a database. The queries can later be analyzed to obtain their characteristics. In the future, appropriate products will be suggested to the user by various means with no or little additional inputs.

Other users of the application can also buy products of the correct size for their friends and family, without the need for worrying about fit. Such social networking features can be built in to the existing social networking infrastructures like Facebook, Orkut, etc. It could also be built in to the existing product for a new social networking experience.

Deployment Of The System

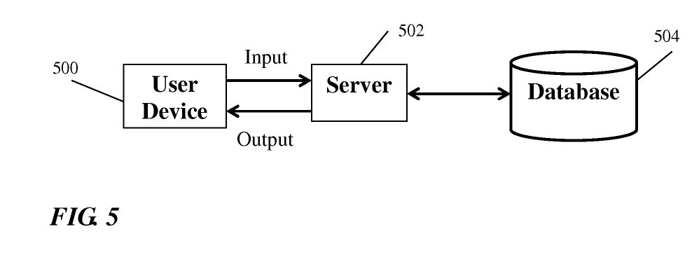

In one embodiment of the invention illustrated in FIG. 5, the user uses a device 500 like a computer, smart phone, mobile phone, tablet etc. to input the details that will be used to recommend products of similar size. The user input is then provided to a server 502 which in turn obtains OI, the OI's fitfunction value, the price, rating etc. from the database 504. Once all the results are collated, the server 502 returns the results back to the user device 500. In addition, the server 502 and the user device 500 will also perform additional tasks for social networking, improving user experience, etc.

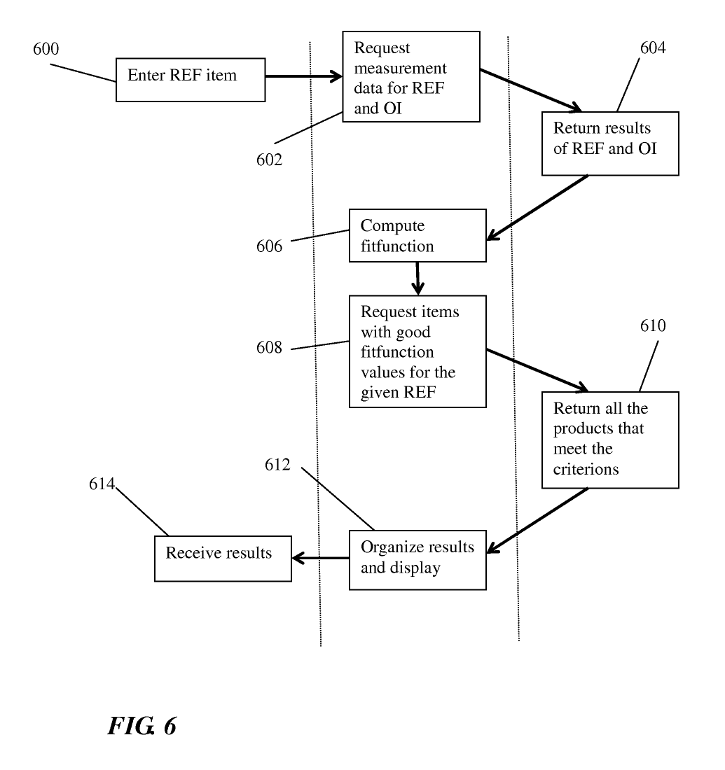

The various processes executed in these parts are shown in FIG. 6. The vertical line of FIG. 6 separates the processes running on the various parts of the system. The user begins by entering the details of the REF item at step 600. The server receives the request and requests the database to return measurements for both REF and OI at steps 602 and 604. The server calculates the fitfunction at step 606. This calculation can be performed at real-time (i.e. when the user inputs the REF item) or can be pre-calculated. The server then requests the database for products that have good fitfunction value for the given REF at step 608. All results that meet the criteria are returned to the server at step 610. The server organizes the results of that database query at step 612, and provides them to the user device for display at step 614.

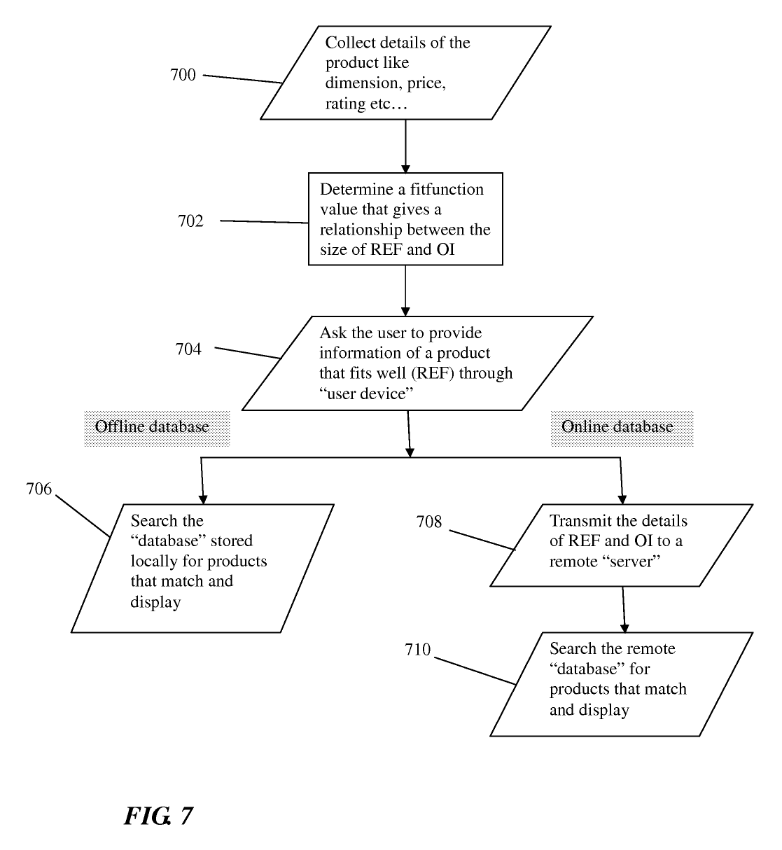

Depending on the location where the process described under the categories of the user device, server and the database, the deployment could be classified in to two versions: server version and desktop version which are both illustrated in FIG. 7.

In the server version, the user inputs the data on a computer, tablet, mobile phone, smart phone etc at step 100 as shown in FIG. 1. The inputs are sent to a remote server and the computations for the critical dimensions and matching with other products are performed on the remote computer at steps 102, 104 and 106. The catalogue on the server's database is then searched and only products matching the requirement are displayed at steps 106.

In one embodiment of the desktop version shown in FIG. 7, the three process steps 700, 702, and 704 are performed on the user device. The server and the database can be deployed on the same device. This device could be the customer computer or mobile phone or any such computing terminal.

In another embodiment of the desktop version, the user device and the server could be combined in one device and the database could be at a remote location at steps 708 and 710.

In yet another embodiment of the desktop version, the user device and database could be in one device and the server could be at a remote location at step 706.

In addition, the desktop or server version can be embedded in other web sites in order to enable searches for products with correct fit from within the website. Embedding refers to the process of placing the input screen in another website/application. The website/application will then be able to access the functionality of the application.

As used herein the terms “determining,” “measuring,” and “assessing,” and “assaying” are used interchangeably and include both “quantitative” and “qualitative” determinations. Quantitative refers to the type of information based on some physically measurable quantity. Qualitative refers to the type of information that is based on characteristics rather than of physically measurable quantity.

The methods described herein are carried out in part with the aid of a computer-based system that includes and is not limited to personal computers, servers, clusters, mobile phone, smart phones, tablets, etc.

The term “difference” as used herein means the mathematical computation of a value to determine a quantitative score that measures the closeness of fit score between each critical dimension for each of the apparel items of interest and the reference apparel item. In one embodiment, the difference can be obtained by means of subtraction of one value from another. In another embodiment, the difference can be obtained by division of one value and another. In other embodiments, the difference could be obtained by other mathematical computations including a combination of subtraction, division, multiplication, and/or addition.

The term “database” has its usual meaning and refers to a structured collection of records or data that is stored in a computer such that software can be used to search and retrieve a response to user queries. The records retrieved in answer to queries become information that can be used to make other choices for/by the user.

In certain embodiments, the subject methods include a step of transmitting data to a remote location for further analysis. “Remote location” is meant a location other than the location at which the initial data about the product to be purchased is entered. For example, a remote location could be another location (e.g. office, lab, etc.) in the same city, another location in a different city, another location in a different state, another location in a different country, etc. As such, when one item is indicated as being “remote” from another, it is meant is that the two items are at least in different buildings, may be at least one mile, ten miles, or may be even one hundred miles apart. In certain embodiments, the remote location indicates a server that performs the determinations or measurements of the invention.

The term “transmitting”, when applied to information used in the methods of the invention, means sending the data the information as electrical signals over a suitable communication channel (for example, a private or public network). The data may be transmitted to the remote location for further evaluation and/or use. Any convenient telecommunications means may be employed for transmitting the data, e.g., facsimile, modem, internet, etc.

In an embodiment, the methods described herein may use a single computer or the like with a stored algorithm capable of performing analysis as described herein, i.e. a electronically implemented computational analysis system that performs the measurements of the invention. In certain embodiments, the system is further characterized in that it provides a user interface, wherein the user interface is any device or system that receives input from the user and displays various data outputs to the user, and/or a system to provide multiple data for input or selection by the user. For example, in the methods described herein, products matched to the dimensions determined from the data input by the user can be displayed on a user interface. Examples of user interfaces include, without limitation, computer terminals or monitors, mobile phone, smart phones, tablets, cell phones, other wireless devices, and the like.

In one aspect, the present invention provides a method for the purchase of an article of apparel. Examples of apparel include, without limitation, dress shirts, t-shirts, trousers, blouses, skirts, socks, gloves, mittens, shoes and the like. In another aspect, the methods of the present invention are used to buy articles of apparel that have a tailored fit specific to a particular customer. Such items of apparel include, for example, suits, tailored blouses, sweaters, and the like, without limitation. In another aspect, the present invention provides a method for the purchase of personal accessories. Examples of personal accessories include watches, bracelets, rings, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An apparel item sizing process for ascertaining best fitting apparel items for a particular apparel item type from a plurality of product offerings, the process comprising:
collecting apparel item details for future analysis and dissemination by inputting into an electronic database apparel item details for a plurality of brand manufacturers and/or retailers, the apparel item details comprising at least one of categorical apparel item type, brand name, brand line, pricing, apparel item dimensions, apparel item color, potential apparel item popularity based on reviews, location of the apparel item, and apparel item ratings; and
utilizing an electronically implemented computational analysis system to determine a closeness of fit score, wherein the closeness of fit score compares a reference apparel item known to fit a customer based upon prior experience to the collected apparel item details of the electronic database, and wherein the closeness of fit score is derived from a formula utilizing at least one critical dimension that is key to the satisfaction of the customer; and
identifying one or more apparel items of interest based upon the closeness of fit score.

2. The process of claim 1, wherein the items have multiple critical dimensions, and wherein the closeness of fit score is measured as a combination of the difference between each critical dimension for each of the apparel items of interest and the reference apparel item.

3. The process of claim 1, wherein a weight or penalty is assigned to each critical dimension such that each critical dimension contributes a greater or lesser amount to the closeness of fit score.

4. The process of claim 3, wherein smaller sizes are penalized with a very large weight so that users can only buy clothing that is either similar to or bigger than the reference apparel item.

5. The process of claim 1, wherein the process can be implemented utilizing either a server or a desktop version.

6. The process of claim 1, wherein the results of the closeness of fit score are stored on database for future further retrieval.

7. The process of claim 1, wherein the closeness of fit score is pre-calculated or calculated in run-time.

8. The process of claim 1, further comprising inputting via a form details of the reference apparel item including at least one of the brand, type or size of the reference apparel item, and wherein the customer is prompted to choose from pre-determined apparel choices or has the option to enter a search term to better select the one or more apparel items of interest.

9. The process of claim 8, further comprising identifying search results including the one or more apparel items of interest via a display to the customer based on the closeness of fit score along with a recommendation on the size of the item most likely to satisfy the user.

10. The process of claim 9, wherein the search results additionally display at least one of the image of the apparel items of interest, price, quality of match established using the closeness of fit score, size the customer has to purchase, ratings, name of the product, brand, details of a store where the product is available.

11. The process of claim 1 wherein the customer can become authenticated on the system and any query made by the customer is then stored in a database, wherein once authenticated the queries of the customer are analyzed to obtain characteristics that allow for appropriate products to be suggested to the customer.

12. An apparel item sizing system for ascertaining best fitting apparel items for a particular apparel item type from a plurality of product offerings, the system comprising:
at least one server for hosting a website, the website including an input form for inputting details of a reference apparel item known to fit a customer based upon prior experience including at least one of the brand, type or size of the reference apparel item;
at least one electronic database that stores apparel item details for a plurality of brand manufacturers and/or retailers as well as customer details, wherein the apparel item details comprise at least one of categorical apparel item type, brand name, brand line, pricing, apparel item dimensions, apparel item color, potential apparel item popularity based on reviews, location of the apparel item, and apparel item ratings; and
apparel item sizing software, wherein the software is adapted to determine a closeness of fit score, wherein the closeness of fit score compares the reference apparel item to the collected apparel item details of the electronic database, and wherein the closeness of fit score is derived from a formula utilizing at least one critical dimension that is key to the satisfaction of the customer.

13. The apparel item sizing system of claim 12, further comprising at least one networked device for accessing the website over a communication network.

14. The apparel item sizing system of claim 12, wherein the items have multiple critical dimensions, and wherein the closeness of fit score is measured as a combination of the difference between each critical dimension for each of the apparel items of interest and the reference apparel item.

15. The apparel item sizing system of claim 12, wherein the sizing system is embedded in other websites in order to enable searches for products with correct fit from within the website

16. The apparel item sizing system of claim 12, wherein the system is used when purchasing at a brick-and-mortar store, and wherein display results include at least one of a location of apparel in the store, a quantity of apparel still available in the store, and/or a direction to the apparel location in the store.

17. The apparel item sizing system of claim 12, wherein the customer details include authentication on the system which allows any query made by the customer to be stored in a database, wherein once authenticated the queries of the customer are analyzed to obtain characteristics that allow for appropriate products to be suggested to the customer.

18. The apparel item sizing system of claim 12, wherein the customer details include results of the closeness of fit score which are stored on database for further retrieval.

19. The apparel item sizing system of claim 12, wherein a size of the reference apparel item is used to determine a size of the apparel to be manufactured in addition to or in alternative to choosing from a pre-populated data base of already manufactured apparel.

20. A computer program stored on computer readable medium to implement a method for ascertaining best fitting apparel items for a customer from a plurality of product offerings, the method comprising:
inputting onto a electronic database apparel item details for a plurality of brand manufacturers and/or retailers, the apparel item details comprising at least one of categorical apparel item type, brand name, brand line, pricing, apparel item dimensions, apparel item color, potential apparel item popularity based on reviews, location of the apparel item, and apparel item ratings;
inputting via a form details of the reference apparel item including at least one of the brand, type or size of the reference apparel item, and wherein the customer is prompted to choose from pre-determined apparel choices or has the option to enter a search term to better select one or more apparel items of interest;
utilizing an electronically implemented computational analysis system to determine a closeness of fit score, wherein the closeness of fit score compares a reference apparel item known to fit a customer based upon prior experience to the collected apparel item details of the electronic database, and wherein the closeness of fit score is derived from a formula utilizing at least one critical dimension that is key to the satisfaction of the customer; and
identifying one or more apparel items of interest based upon the closeness of fit score.

21. The computer program of claim 19, wherein the items have multiple critical dimensions, and wherein the closeness of fit score is measured as a combination of the difference between each critical dimension for each of the apparel items of interest and the reference apparel item.
